(19) United States
(12) Patent Application Publication
(10) Pub. No.: US 2018/0177001 A1
(43) Pub. Date: Jun. 21, 2018

(54) Enhanced Coreless Induction Furnace Stirring

(71) Applicant: Ajax Tocco Magnethermic Corp., Albertville, AL (US)

(72) Inventor: Dave Lazor, Albertville, AL (US)

(21) Appl. No.: 15/841,567

(22) Filed: Dec. 14, 2017

Related U.S. Application Data
(60) Provisional application No. 62/434,546, filed on Dec. 15, 2016.

(51) Int. Cl. H05B 6/36; H05B 6/06; H05B 6/04

(52) U.S. Cl. CPC H05B 6/367; H05B 2213/02; H05B 6/04; H05B 6/067

(57) ABSTRACT

A multi-section coil enhanced stirring system wherein only one of the coils is powered from a single-phase AC source to enhance the stirring of the metal.

The present invention claims priority on U.S. Application Ser. No. 62/434,546 filed Dec. 15, 2016, which is fully incorporated therein by reference.

The present invention is directed to a coil enhanced stirring system wherein only a portion of a perimeter of an electrically conductive material to be melted is caused to be stirred by induction coils, more particularly to a coil enhanced stirring system wherein only a portion of a perimeter of an electrically conductive material to be melted is caused to be stirred by induction coils and the induction coils are powered from a single-phase AC source, still more particularly to a coil enhanced stirring system wherein only a top or bottom portion of a perimeter of an electrically conductive material to be melted is caused to be stirred by induction coils and the induction coils are powered from a single-phase AC source, yet more particularly to a multi-section coil enhanced stirring system wherein only a top or bottom portion of a perimeter of an electrically conductive material to be melted is caused to be stirred by induction coils and only a portion of the induction coils of the multi-section coil enhanced stirring system is powered from a single-phase AC source, and still yet more particularly to a multi-section coil enhanced stirring system wherein only a top or bottom portion of a perimeter of an electrically conductive material to be melted is subjected to heating and is caused to be stirred by induction coils and only a portion of the induction coils of the multi-section coil enhanced stirring system is powered from a single-phase AC source.

### BACKGROUND OF INVENTION

In a conventional coreless induction furnace, a coil or several coils are wound around the complete perimeter of a ladle or crucible or other type of container that contains an electrically conductive material to be melted and the coils are also positioned along the complete longitudinal length of the container. When an alternating voltage is applied to the coil winding, an alternating current flows through the coil which generates an electromagnetic field. As this field passes through electrically conductive material located within the inner perimeter of the coil, eddy currents are generated around the perimeter of the material which result in joule heating (FR) of the electrically conductive material.

During the process of induction heating and melting, the induced current flow in the electrically conductive material in the presence of the electromagnetic field results in an electromotive force (Lorentz Force) being generated which acts on the electrically conductive material. When these forces are applied to electrically conductive liquid metal, the forces cause the electrically conductive liquid metal to move within the cavity of the container. This molten metal movement is referred to as “stirring.”

The stirring of any specific electrically conductive liquid metal is affected by the induced current density in the molten metal and the generated field.

Frequency plays a role such that, when operating at a higher frequency, the skin depth at which current flows around the outer perimeter of the molten metal decreases. When the depth of current flow is less, the effective resistance of the load is higher. If the resistance is higher, it takes less current to get the required generated power (W=I²R) in the load. Thus, for a given power, raising the frequency will lower the stirring forces of the molten metal and decrease stirring velocity. Inversely, lowering the frequency makes the induced current flow deeper in the electrically conductive material thereby making the effective resistance of the load lower. At a lower frequency with a lower load resistance, a higher induced current is required to achieve the same required power. Thus, for a given power level, lowering the frequency will increase the stirring forces of the motel metal and increase stirring velocity.

Since power is related to I²R, then increasing the power increases the current which increases the forces that propel the liquid metal, thereby resulting in increased velocity of the molten metal.

Several different methods have been used in the past to provide enhanced stirring when operating at low power levels. As illustrated in FIG. 1, there is illustrated a conventional single-phase induction furnace arrangement 100. The single-phase induction furnace arrangement includes a ladle or crucible or other type of container 110 that includes an internal cavity configured to hold a conductive material M such as a conductive metal (e.g., aluminum). Typically, the container 110 is formed of a non-conductive material, positioned about the complete perimeter of the container is an induction coil 120. The induction coil is also positioned along the full longitudinal length of the container. The induction coil is illustrated as being powered by a power source 130. The power source has its armature set at 0°, thereby generating zero voltage output. When the induction coil is powered by the power source, the metal in the container is heated until it melts, if not already molten. The force arrows 140 represent the force from the electromagnetic field that is exerted on the metal in the container when the induction coil is powered by the power source. The length of the force arrows represent the relative amount of inward force along the height of the coil that is applied to metal in the container. The top and bottom portion of the coil illustrates the force arrows as being smaller than the force arrows located in the mid-region of the coil. As such, the amount of force applied on the metal in the container is greatest in the middle of the longitudinal length of the coil and is weakest and the top and bottom of the coil. The alternating current through the induction coil generated by the power source creates an inward magnetic field or electromotive force F, as represented by the force arrows, which causes the stirring effect and flow pattern of the molten metal in the container as illustrated by flow arrows 150. As illustrated by the flow arrows, four quadrants of stirring are created: two quadrants at the top half of the container and two quadrants at the bottom half of the container. Each of the quadrants are generally equal in size and the stirring speed in each quadrant is generally the same. The stirring direction of the molten metal at the top left quadrant of the container is counter-clockwise; the stirring direction of the molten metal at the top right quadrant of the container is clockwise. The stirring direction of the molten metal at the bottom left quadrant of the container is clockwise; the stirring direction of the molten metal at the bottom right quadrant of the container is counter-clockwise. For a conventional single-phase induction furnace arrangement as illustrated in FIG. 1, at a given operating power level, lowering the induction frequency increases the forces exerted on the molten metal, thereby resulting in higher molten metal velocity than at higher frequencies.

Two other prior art conventional single-phase induction furnace arrangements are illustrated in FIGS. 2 and 3. The configuration of the single-phase induction furnace arrangement is similar to the arrangement as illustrated in FIG. 1 except for the wiring of the induction coil to the power source. The alternating current flow occurs in both the top and bottom sections of the induction coil, wherein as the alternating current flow illustrated in FIG. 1 occurs over the full length of the induction coil. The stirring pattern of the molten metal in the container and the force distribution on the molten metal is also similar to the stirring pattern and force distribution discussed with respect to the single-phase induction furnace arrangement illustrated in FIG. 1.

As illustrated in FIGS. 4-6, there is illustrated three prior art multiphase induction furnace arrangements. The configuration of the multiphase induction furnace arrangement creates a different stirring pattern and force distribution than the single-phase induction furnace arrangements illustrated in FIGS. 1-3. As illustrated in FIG. 4, there are two power sources 130, 132. Power source 130 has its armature set at 0° and power source 132 has its armature set at −90°. The two power sources create a generally uniform inward electromotive force F as represented by the force arrows 140. Such electromotive force causes the stirring effect and flow pattern of the molten metal in the container as illustrated by flow arrows 150. As illustrated by the flow arrows, stirring occurs in each half of the container along the longitudinal length of the container. The stirring speed in each half of the container is generally the same. The stirring direction of the molten metal at the right half the container is clockwise and the stirring direction of the molten metal at the left half the container is counter-clockwise.

As illustrated in FIG. 5, there are three power sources 130, 134 and 136. Power source 130 has its armature set at 0°, power source 134 has its armature set at −120°, and power source 136 has its armature set at 120°. The three power sources create a generally uniform inward electromotive force F as represented by the force arrows 140. Such electromotive force causes the stirring effect and flow pattern of the molten metal in the container as illustrated by flow arrows 150. As illustrated by the flow arrows, stirring occurs in each half of the container along the longitudinal length of the container. The stirring speed in each half of the container is generally the same. The stirring direction of the molten metal at the right half the container is clockwise; the stirring direction of the molten metal at the left half the container is counter clockwise.

As illustrated in FIG. 6, there are four power sources 130, 132, 136 and 138. Power source 130 has its armature set at 0°, power source 132 has its armature set at −90°, power source 136 has its armature set at −180°, and power source 138 has its armature set at −270°. The four power sources generate an upward traveling electromagnetic wave which creates a generally uniform inward and upward electromotive force F as represented by the force arrows 140. Such electromotive force causes the stirring effect and flow pattern of the molten metal in the container as illustrated by flow arrows 150. As illustrated by the flow arrows, stirring occurs in each half of the container along the longitudinal length of the container. The stirring speed in each half of the container is generally the same. The stirring direction of the molten metal at the right half the container is clockwise; the stirring direction of the molten metal at the left half the container is counter-clockwise.

### SUMMARY OF THE INVENTION

The present invention is directed to a system that provides improved stirring control of electrically conductive material via induction heating. In one aspect of the invention, there is provided a coil enhanced stirring system wherein power from the induction coil is applied to only a portion of the cavity of the crucible or ladle or other type of container that contains the conductive material (e.g., power applied to only top portion of the cavity of the container, power supplied to only the bottom portion of cavity of the container). Such a stirring arrangement is a departure from prior art stirring arrangements wherein power from the induction coils is applied to the complete portion of the longitudinal length of the cavity of the container that contains the molten metal. In one non-limiting embodiment, there is provide an induction coil that is powered from a single-phase AC source and which extends only a portion of the longitudinal length of the cavity of the container that contains the electrically conductive material. For example, if 100% of the height or longitudinal length of the cavity of the container is filled with electrically conductive material, the induction coil that is powered by a power source (e.g., AC source) only encircles or partially encircles no more than 90% of the height or longitudinal length of the cavity of the container that is filled with electrically conductive material (e.g., 5-90% of the total height or longitudinal length of the cavity of the container that is filled with electrically conductive material, and all values and ranges therebetween). In one specific non-limiting arrangement, the induction coil only encircles or partially encircles no more than 70% of the height or longitudinal length of the cavity of the container that is filled with electrically conductive material. In another specific non-limiting arrangement, the induction coil only encircles or partially encircles no more than 60% of the height or longitudinal length of the cavity of the container that is filled with electrically conductive material. In another specific non-limiting arrangement, the induction cloil only encircles or partially encircles no more than 50% of the height or longitudinal length of the cavity of the container that is filled with electrically conductive material. In another specific non-limiting arrangement, the induction coil only encircles or partially encircles less than 50% of the height or longitudinal length of the cavity of the container that is filled with electrically conductive material. In another specific non-limiting arrangement, the induction coil only encircles or partially encircles no more than 45% of the height or longitudinal length of the cavity of the container that is filled with electrically conductive material. In another specific non-limiting arrangement, the induction coil only encircles or partially encircles no more than 40% of the height or longitudinal length of the cavity of the container that is filled with electrically conductive material. The stirring arrangement in accordance with the present invention has been found to enhance the stirring of the electrically conductive material. Molten metal stirring during the melting process as well as during process holding periods is a desirable feature in coreless induction furnace systems. Good stirring helps to maintain homogeneity in metallurgy and temperature of the melt. Good stirring also helps to maximize yield on alloy additions while operating at low power for an extended period of time. Stirring can be used to reduce the risk of bridging of charge materials over the top of the molten metal as the charged materials are added to the molten material. The enhanced stirring system for coreless induction furnaces in accordance with the present invention provides these stirring features and advantages.

In one non-limiting aspect of the present invention, there is provided a multi-section coil enhanced stirring system wherein only one of the coils is powered by a power source. In one non-limiting embodiment, there is provided a multi-section coil enhanced stirring system wherein only the top coil or only the bottom coil is powered by a poswer. In another and/or alternative non-limiting embodiment, there is provided a multi-section coil enhanced stirring system wherein only the top coil or only the bottom coil is powered from a single-phase AC source.

In another and/or alternative non-limiting aspect of the present invention, there is provided a novel enhanced induction stirring system wherein the induction furnace can be constructed with two or more individual coil winding sections (e.g., 2-10 individual coil winding section, etc.). When the coils are connected in a conventional melting configuration, all of the powered coils are electrically in parallel such that the currents are in phase with each other as illustrated in FIGS. 1 and 2. After the electrically conductive material has been melted, the power supply to one or more of the coils can be terminated to create the enhanced stirring system in accordance with the present invention. As such, the novel enhanced induction stirring system can be used with existing induction heating and stirring systems, wherein after the electrically conductive material has been heated and at least partially melted by an existing induction heating and stirring system, the existing induction heating and stirring system can be modified in accordance with the present invention, to create the enhanced induction stirring system.

In a prior art coreless induction furnace, as the elevation of the molten metal is raised above the top of the powered induction coil, the meniscus (dome) and the molten metal velocity at the surface of the melt decreases for the same applied power level. As a result of the formation of the meniscus and the reduction in molten metal velocity at the surface of the melt, it becomes more difficult to draw in smaller charged pieces in the stirred mixture, and also increases the risk of bridging, especially when adding charged pieces near the end of the melting of the electrically conductive material. It has been found that by powering only one section of the induction coil for a given applied power level such that only a portion of the electrically conductive material is exposed to the inward electromotive force created by the powered induction coil, the power density in that area of the melted electrically conductive material is exposed to the inward electromotive force is greater than if the same power to the induction coil was applied to the induction coil that encircles the full longitudinal length of the cavity of the container. In the area of the higher concentrated power density, the resulting forces acting on the melted electrically conductive material in such region are also increased. When only powering the induction coil at the top region of the cavity of the container, a higher molten metal meniscus is formed as well as increased molten metal velocity. The increased meniscus and increased surface velocity help to reduce the risk of bridging when charged pieces are added to the top of the molten metal material, and also facilitates in drawing in smaller charged pieces into the molten electrically conductive material, thereby enhancing proper mixing.

In another and/or alternative non-limiting aspect of the present invention, the operating frequency can be reduced to result in increased stirring forces in the molten electrically conductive material. Such increased stirring forces are due to the reduced number of parallel induction coils being used to stir the molten electrically conductive material in the cavity of the container. When there are a reduced number of parallel induction coils positioned along the outer surface of the longitudinal length of the container that includes the molten electrically conductive material, the inward electromotive force as illustrated by the force arrows 140 generated by the reduced number of parallel induction coils is greater than the inward electromotive force generated by a larger number of parallel induction coils positioned along the outer surface of the complete longitudinal length of the container. By using a reduced number of parallel induction coils positioned along the outer surface of the longitudinal length of the container, the connected total inductance increases. With a fixed connected capacitance, as the inductance increases, the resonant frequency decreases. For example, a furnace that includes two stacked induction coils (a top coil and a bottom coil) that are connected in parallel to the power supply (as illustrated in FIG. 2) would operate at a higher frequency as compared to the same arrangement, wherein only one of the two stacked induction coils was powered in accordance with the present invention. When one induction coil is disconnected from the power source, the frequency that is generated by only one of the two stacked inductions coils during the stirring of the electrically conductive material would drop to approximately (1/√2)·x the operating frequency, or only 70.7% of the frequency as compared to the operation of two stacked induction coils that are connected in parallel to the power supply. When the induction stirring system operates at a higher frequency, the skin depth at which current flows around the outer perimeter of the electrically conductive material decreases. When the depth of current flow is less, the effective resistance of the load is higher. As such, for a given power, raising the frequency will lower the stirring forces of the molten metal and decrease stirring velocity. When one of the two stacked induction coils are disconnected from the power source, the operating frequency of the induction stirring system while the power from the power source remains constant, thereby making the induced current flow deeper in the electrically conductive material, thus making the effective resistance of the load lower. Thus, for a given power level, lowering the frequency will increase the stirring forces of the electrically conductive material in the cavity of the container, thereby increasing stirring velocity in the container. Such increased stirring velocity results in improved mixing of the electrically conductive material, especially when charged pieces are added to the electrically conductive material during mixing.

In one non-limiting aspect of the present invention, there is provided an apparatus for stirring a molten or semi-molten material that is subjected to a magnetic field formed by an energized induction coil. The apparatus includes a container having a cavity that is designed to contain the material. The induction coil includes a first induction coil section that is at least partially positioned about the cavity of the container. The first induction coil section is configured to form a magnetic field when energized that affects the material in the cavity and causes the material in the cavity to be stirred. A power supply is provided to energize the first induction coil section. The first induction coil section is positioned at least partially about an outer perimeter of the container. The first induction coil section is also positioned along a longitudinal length of the cavity such that, when the first induction coil section is energized, such that only a portion of the induction coil causes the material in the cavity to be stirred, at least 10% of a longitudinal height of the material in the cavity that is measured along the longitudinal length of the cavity is positioned above or below the energized first induction coil section. In one non-limiting embodiment, the power source that energizes the first induction coil section when only the first induction coil section is used to stir the material in the cavity can be a single AC power source. In another and/or alternative non-limiting embodiment, at least 40% of the longitudinal height of the material in the cavity that is measured along said longitudinal length of the cavity is positioned above or below said energized first induction coil section. In another and/or alternative non-limiting embodiment, at least 50% of the longitudinal height of the material in the cavity that is measured along said longitudinal length of the cavity is positioned above or below said energized first induction coil section. In another and/or alternative non-limiting embodiment, at least 60% of the longitudinal height of the material in the cavity that is measured along said longitudinal length of the cavity is positioned above or below said energized first induction coil section. In another and/or alternative non-limiting embodiment, the induction coil includes a second section that is energized by the same or different power source used to power the first induction coil section. The first and second induction coil sections are configured to heat the material in the cavity. The second induction coil section is also configured to be deenergized when only the first induction coil section is used to stir the material in the cavity. As such, if the material in the cavity is not sufficiently molten and/or is desirable to be further heated, the first and second induction coil sections can be optionally used to provide such heating to the material. After the material has been sufficiently heated and is ready to be stirred by the novel stirring process of the present invention, the second induction coil section is deenergized while the first coil section remains energized to thereby cause the material in the cavity to be stirred solely by the energized first induction coil section. In another and/or alternative non-limiting embodiment, the induction coil includes a third section that is energized by the same or different power source used to power the first induction coil section. The first, second and third induction coil sections are configured to heat the material in the cavity. The second and third induction coil sections are configured to be deenergized when only the first induction coil section is used to stir the material in the cavity. As such, if the material in the cavity is not sufficiently molten and/or is desirable to be further heated, the first, second and third induction coil sections can be optionally used to provide such heating to the material. After the material has been sufficiently heated and is ready to be stirred by the novel stirring process of the present invention, the second and third induction coil sections are deenergized while the first coil section remains energized to thereby cause the material in the cavity to be stirred solely by the energized first induction coil section. In another and/or alternative non-limiting embodiment, there is provided a method of stirring a molten or semi-molten material that is subjected to a magnetic field. The method includes a) inserting the material in a cavity of a container, wherein the cavity has a longitudinal length that extends from a top to a bottom of the cavity; b) providing an induction coil that includes a first induction coil section, and wherein the first induction coil section is at least partially positioned about the cavity of the container; c) applying power to the induction coil such that the material in the cavity is subjected to a magnetic field that is only formed by the first induction coil, which magnetic field causes the material to be stirred in the cavity, and wherein at least 10% of a longitudinal height of the material in the cavity that is measured along the longitudinal length of the cavity is positioned above or below the energized first induction coil section during the stirring of the material in the cavity. In another and/or alternative non-limiting embodiment, the energization of only the first induction coil section during the stirring of the material in the cavity causes first and second top quadrants of the material and first and second bottom quadrants of the material to form and be stirred in the cavity. The first top quadrant of material has a rotational direction that is opposite a rotational direction of said second top quadrant of the material. The first bottom quadrant of the material has a rotational direction that is opposite a rotational direction of the second bottom quadrant of the material. A combined volume of the material in the first and second top quadrants is at least 10% different from a combined volume of the material in the first and second bottom quadrants. In another and/or alternative non-limiting embodiment, the combined volume of the material in the first and second top quadrants at least 30% different from the combined volume of the material in the first and second bottom quadrants. In another and/or alternative non-limiting embodiment, the combined volume of the material in the first and second top quadrants at least 50% different from the combined volume of the material in the first and second bottom quadrants. In another and/or alternative non-limiting embodiment, the combined volume of the material in the first and second top quadrants at least 60% different from the combined volume of the material in the first and second bottom quadrants. In another and/or alternative non-limiting embodiment, the rotational speed of the material in the first and second top quadrants is at least 10% different from the rotational speed of the material in the first and second bottom quadrants. In another and/or alternative non-limiting embodiment, the rotational speed of the material in the first and second top quadrants is at least 30% different from a rotational speed of the material in the first and second bottom quadrants. In another and/or alternative non-limiting embodiment, the rotational speed of the material in the first and second top quadrants is at least 50% different from the rotational speed of the material in the first and second bottom quadrants. In another and/or alternative non-limiting embodiment, the rotational speed of the material in the first and second top quadrants is at least 60% different from the rotational speed of the material in the first and second bottom quadrants. In another and/or alternative non-limiting embodiment, charged particles, alloy particles, or combinations thereof are added to the material prior to the stirring of the material, during the stirring of the material, or combinations thereof. In another and/or alternative non-limiting embodiment, the first induction coil section is powered at a resonance frequency of a circuit used to power the first induction coil section.

One non-limiting object of the present invention is the provision of an induction furnace system that provides improved stirring control of electrically conductive material via induction heating.

Another and/or alternative non-limiting object of the present invention is the provision of an induction furnace system wherein power from the induction coil is applied to only a portion of the cavity of the container that contains the conductive material.

Another and/or alternative non-limiting object of the present invention is the provision of an induction furnace system wherein power is supplied to only the bottom portion of cavity of the container or only the top portion of cavity of the container.

Another and/or alternative non-limiting object of the present invention is the provision of an induction furnace system wherein an induction coil is powered from a single-phase AC source and which extends only a portion of the longitudinal length of the cavity of the container that contains the electrically conductive material.

Another and/or alternative non-limiting object of the present invention is the provision of an induction furnace system that enhances the stirring of the electrically conductive material.

Another and/or alternative non-limiting object of the present invention is the provision of an induction furnace system that helps to maximize yield on alloy additions.

Another and/or alternative non-limiting object of the present invention is the provision of an induction furnace system that reduces the risk of bridging as the charged materials are added to the molten material.

Another and/or alternative non-limiting object of the present invention is the provision of an induction furnace system wherein the operating frequency is reduced to result in increased stirring forces in the molten electrically conductive material.

These and other objects and advantages will become apparent to those skilled in the art upon the reading and following of this description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein;

FIG. 1 illustrates a prior art conventional single-phase induction furnace arrangement that includes a single induction coil arrangement that is powered by a single power source;

FIG. 2 illustrates a prior art conventional single-phase induction furnace arrangement that includes two stacked induction coils that are powered by a single power source;

FIG. 3 illustrates a prior art conventional single-phase induction furnace arrangement that includes three stacked induction coils that are powered by a single power source;

FIG. 4 illustrates a prior art conventional induction furnace arrangement that includes two stacked induction coils that are powered by two power sources having different phases;

FIG. 5 illustrates a prior art conventional induction furnace arrangement that includes three stacked induction coils that are powered by three power sources having different phases;

FIG. 6 illustrates a prior art conventional induction furnace arrangement that includes four stacked induction coils that are powered by four power sources having different phases;

FIG. 7 illustrates a single phase induction furnace arrangement that uses a single induction coil arrangement that is powered by a single power source to heat and stir the top portion of the cavity of a container that includes an electrically conductive material;

FIG. 8 illustrates a single-phase induction furnace arrangement that uses a single induction coil arrangement that is powered by a single power source to heat and stir the bottom portion of the cavity of a container that includes an electrically conductive material;

FIG. 9 illustrates a single-phase induction furnace arrangement that uses a single induction coil arrangement that is powered by a single power source to heat and stir the top portion of the cavity of a container that includes an electrically conductive material while large charged pieces are applied to the electrically conductive material;

FIG. 10 illustrates a single-phase induction furnace arrangement that uses a single induction coil arrangement that is powered by a single power source to heat and stir the top portion of the cavity of a container that includes an electrically conductive material while small charged pieces are applied to the electrically conductive material;

FIG. 11 illustrates another single-phase induction furnace arrangement that uses a single induction coil arrangement that is powered by a single power source to heat and stir the top portion of the cavity of a container that includes an electrically conductive material; and,

FIG. 12 illustrates a series LC circuit that can optionally be used to power the induction coils.

### DESCRIPTION OF NON-LIMITING EMBODIMENTS OF THE INVENTION

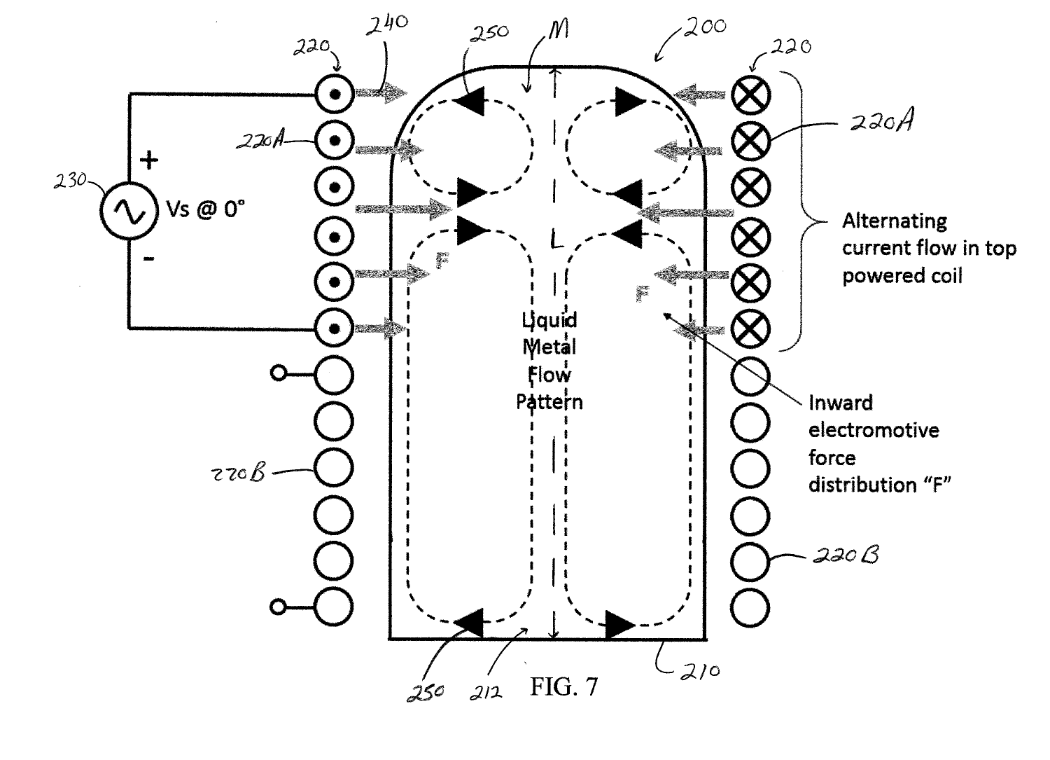

Referring now in greater detail to the drawings, wherein the showings are for the purpose of illustrating various embodiments of the invention only, and not for the purpose of limiting the invention, the present invention is directed to an apparatus and a method for enhanced stirring of melted electrically conductive material in an induction furnace. Non-limiting embodiments of the invention are illustrated in FIGS. 7-12. The apparatus and method in accordance with the present invention provides improved stirring control of electrically conductive material via induction heating. The electromotive force F that is produced by a powered induction coil located about the perimeter of a container (e.g., crucible, ladle, etc.) of the induction furnace is only applied to a portion of the longitudinal length L of the cavity of the container that contains the conductive material. Such a stirring arrangement for use in an induction furnace is novel to the art. The portion of the longitudinal length of the cavity of the container that is exposed to the electromotive force can be the top portion or the bottom portion of the container. Generally, the induction coil that is used to generate the electromotive force about a portion of the longitudinal length of the cavity of the container is a single-phase AC source. The apparatus and method in accordance with the present invention also has been found to facilitate in maximizing yield on alloy additions and to reduce the risk of bridging as the charged materials are added to the molten material during the stirring process. The apparatus and method in accordance with the present invention also reduces the operating frequency for a given power source, which results in increased stirring forces being applied to the molten electrically conductive material.

Referring now to FIG. 7, there is illustrated a single-phase induction furnace arrangement 200 in accordance with the present invention. The single-phase induction furnace arrangement includes a container 210 (e.g., ladle, crucible, etc.) that includes an internal cavity 212 which is configured to hold an electrically conductive material M. Generally, the container is formed of a material that does not interfere with the heating of the electrically conductive material by the induction coil and/or does not overheat during the heating and stirring of the electrically conductive material in the container (e.g., container with high silicon carbide content, container with high clay content, container made from graphite, container made from stainless steel alloys and lined with graphite, silicon nitride, and/or other refractory ceramic materials, container made from a ceramic refractory. etc.). In one non-limiting arrangement, the container is partially or fully formed of a non-electrically conductive material; however, this is not required. The electrically conductive material is generally a metal such as iron, steel, copper, aluminum, and precious metals; however, other electrically conductive materials can be used. In one non-limiting embodiment, the electrically conductive material is pure aluminum or an aluminum alloy, wherein the aluminum alloy includes at least 77.55 weight percent aluminum and at least one metal selected from the group consisting of copper, iron, magnesium, manganese, nickel, silicon, tin, titanium and zinc. The size and shape of the container is non-limiting. Generally, the cavity of the container has a generally circular cross-sectional shape along the longitudinal length L of the cavity; however, this is not required.

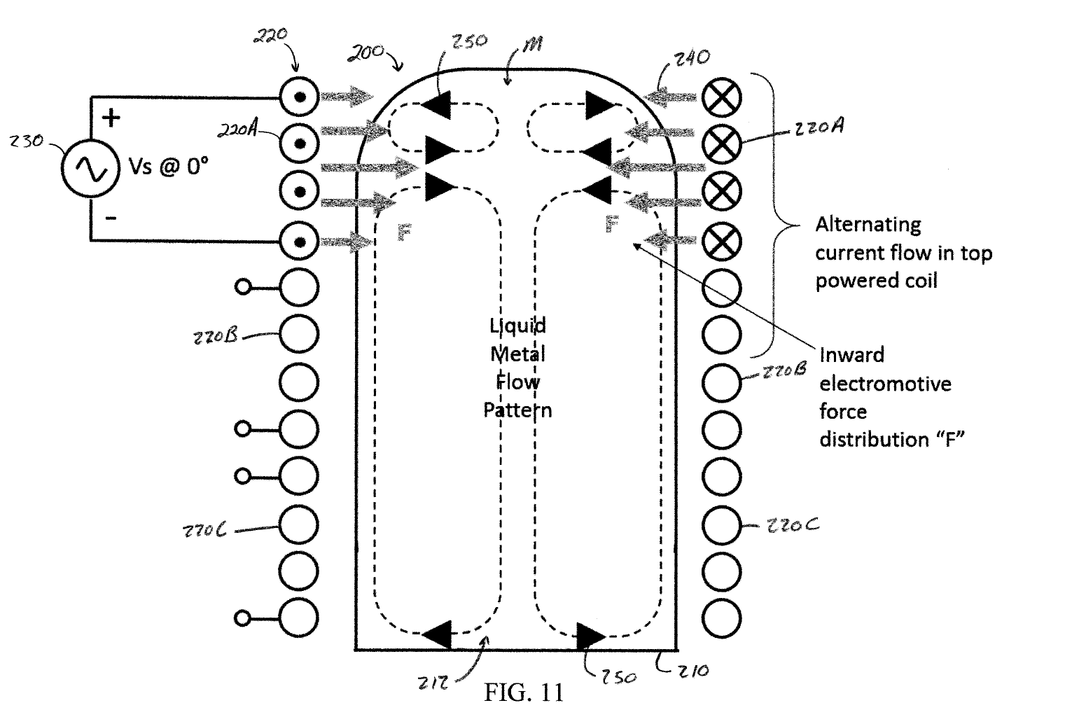

Positioned about the perimeter of the container is an induction coil 220. The induction coil is divided into a first stack 220A and a second stack 220B that is located below the first stack. The two stacks of induction coils encircle the container and extend along the complete longitudinal length of the cavity of the container. As illustrated in FIG. 7, the top stack 220A is positioned about the top half of the cavity of the container and bottom stack 220B is positioned about the bottom half of the cavity of the container. As can be appreciated, different induction coil configurations about the cavity of the container can be used in accordance with the present invention. For example, stack 220A can be positioned about more than or less than the top half of the cavity of the container. Likewise, stack 220B can be positioned about more than or less than the bottom half of the cavity of the container. Also, the induction coil can be configured to only have a single coil stack positioned about the perimeter of the cavity of the container. Alternatively, the induction coil can be configured to be formed of three or more coil stacks positioned about the perimeter of the cavity of the container (See FIG. 11 for an example of three coil stacks). The size of the multiple stacks can the same or different size, and/or be formed of the same or different materials. When the induction coil is configured to have only a single coil stack positioned about the perimeter of the cavity of the container, the single coil stack extends generally no more than 90% of the longitudinal length L of the cavity of the container. Generally, the induction coil is formed of a copper tube or other type of electrically conductive tube that is internally coiled by coolant (e.g., water, etc.) that flows through the tube. Also, the induction coil is generally spaced from the outer perimeter of the container; however, this is not required.

The induction coil is powered by a power source 230. The power source is illustrated as having the armature set at 0°, thereby generating zero voltage output; however, this is not required. The power source is configured to generate a rapidly reversing magnetic field or electromotive force F that penetrates the electrically conductive material in the cavity of the container. The magnetic field or electromotive force induces eddy currents inside the electrically conductive materials by electromagnetic induction. The eddy currents that encounter resistance as the eddy current flows through the electrically conductive materials heats the electrically conductive materials by Joule heating and possibly by magnetic hysteresis. Once the electrically conductive material has melted, the eddy currents cause stirring of the electrically conductive materials in the container. The power supply 230 generally has an operating frequency of 50 Hz to 400 kHz or higher, and generally has a power range of 10 kW to 50 MW; however, it can be appreciated that the power supply can operate at other frequencies and/or have other power ranges.

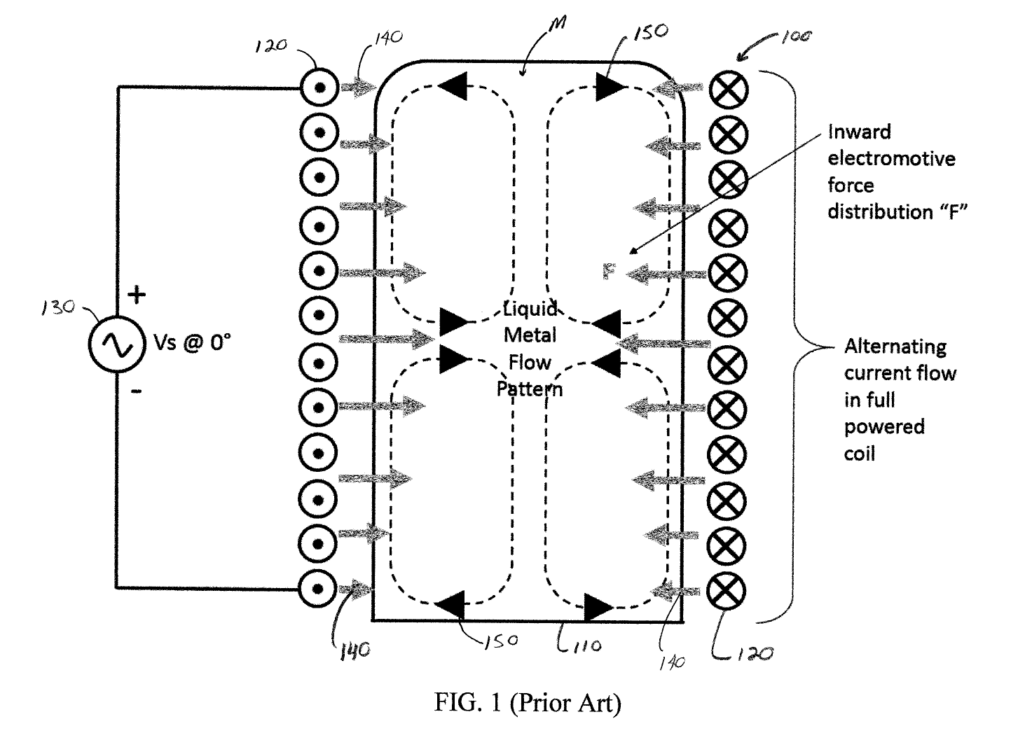

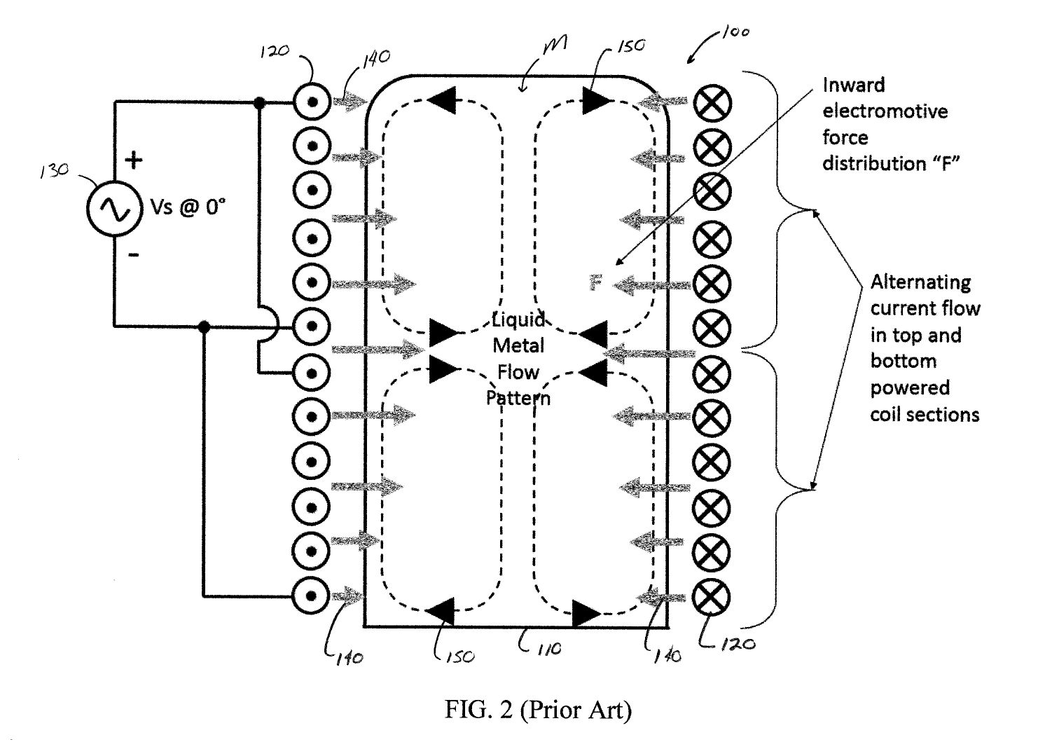

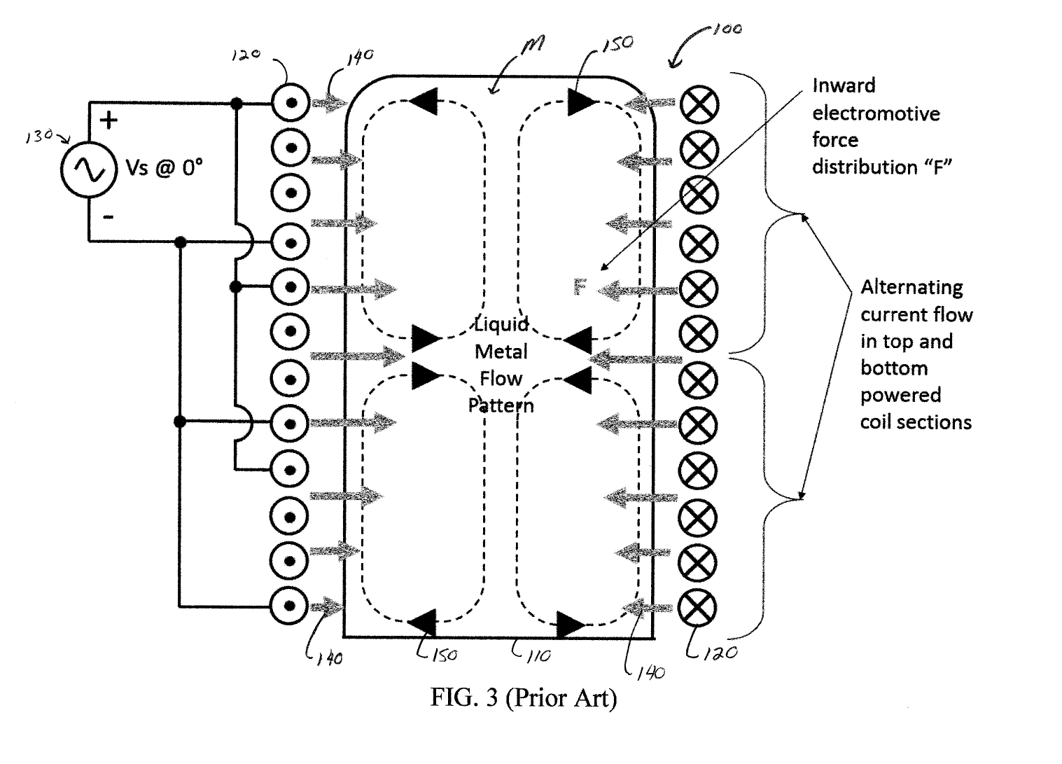

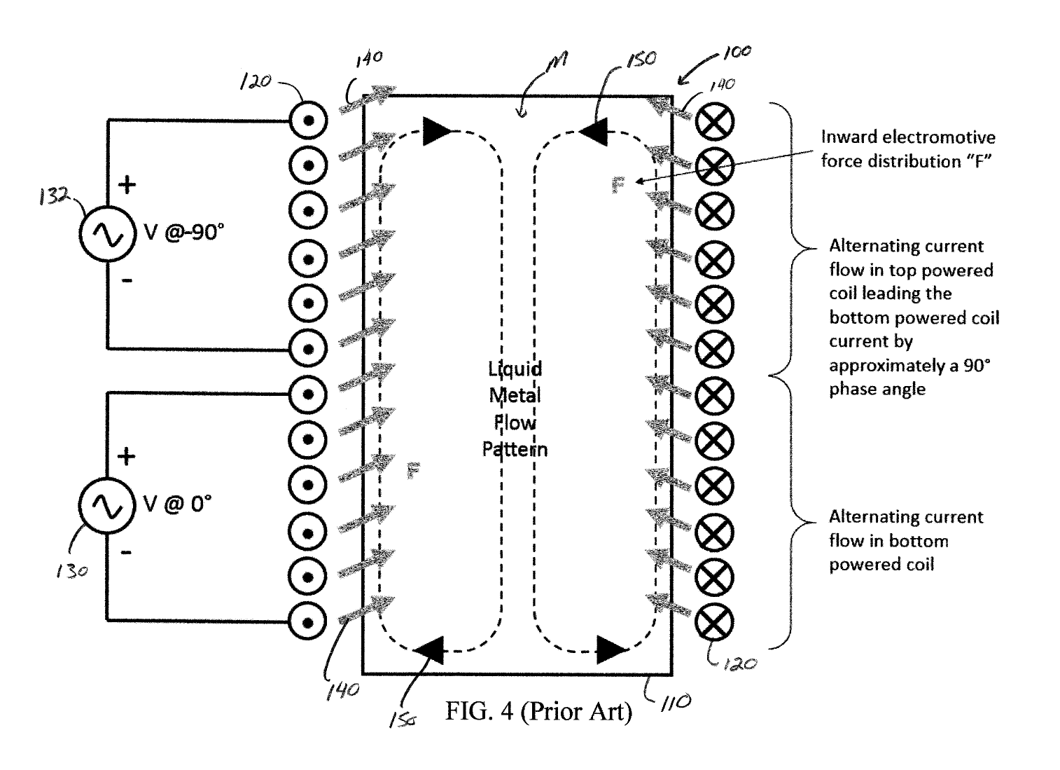

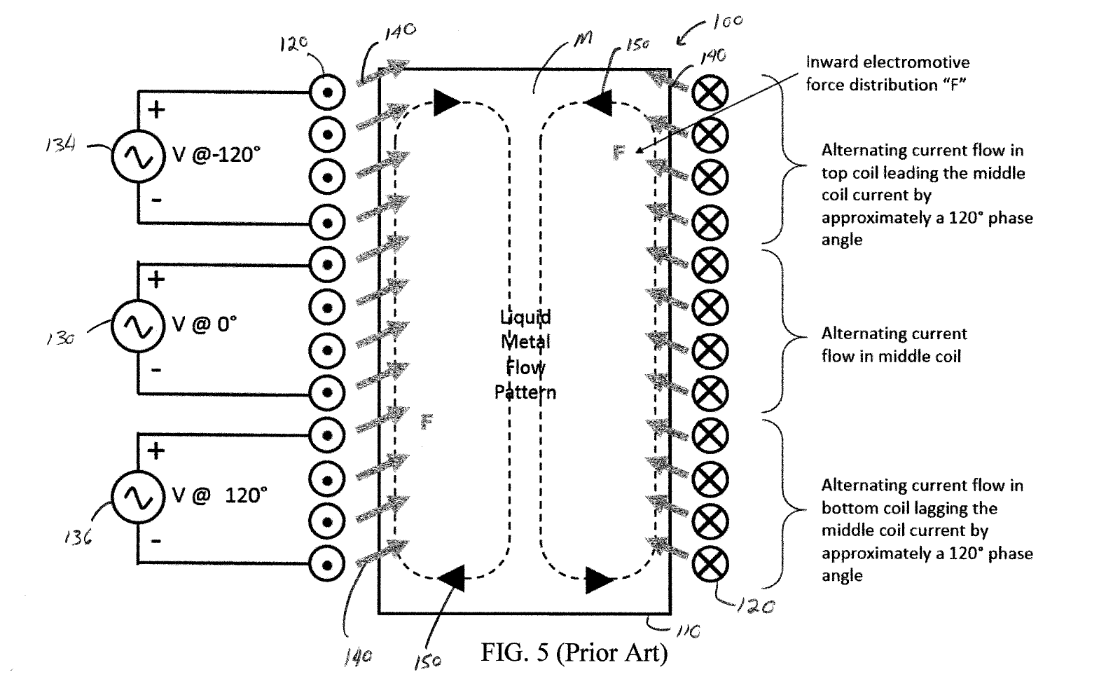

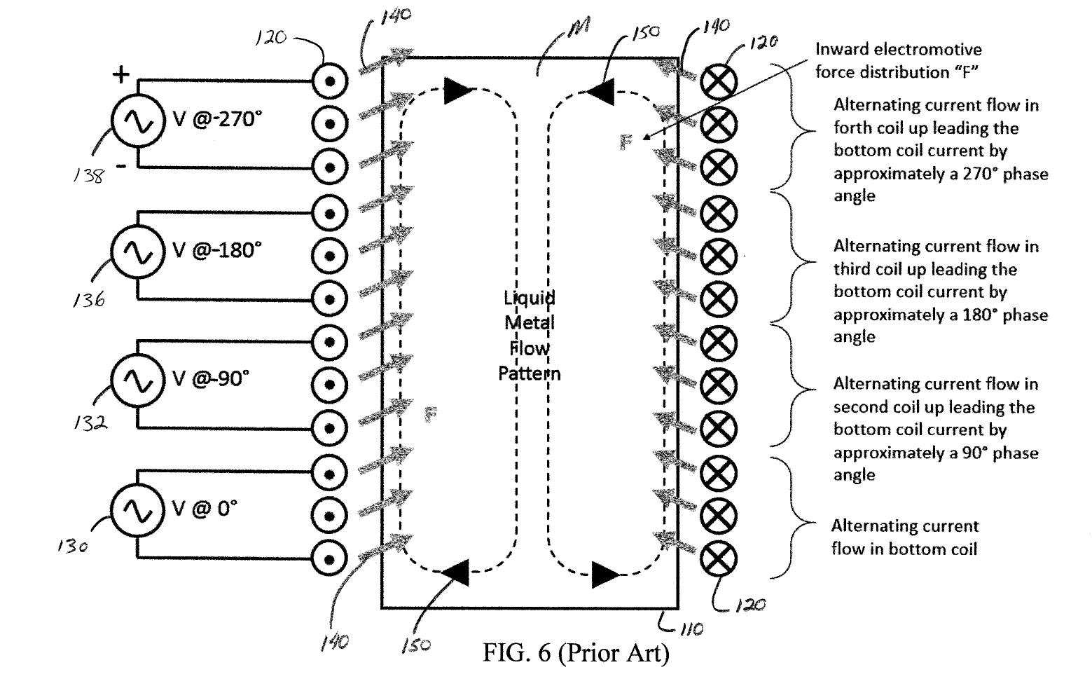

The novel stirring arrangement in accordance with the present invention occurs when the electrically conductive material in the container is in a melted or molten state to enable fluid movement of the electrically conductive material in the cavity of the container. The electrically conductive material can be added to the cavity of the container while in a melted or molten state, and/or the electrically conductive material can be heated in the cavity of the container to achieve a desired melted or molten state prior to applying the novel stirring arrangement in accordance with the present invention to the electrically conductive material in the container. When the electrically conductive material in the cavity of the container is to be heated prior to applying the novel stirring arrangement, the electrically conductive material can be heated by powering one or more stacks of induction coils that generally extend the full longitudinal length L of the cavity as illustrated in FIGS. 1-6; however, this is not required. Once the electrically conductive material in the cavity of the container is sufficiently heated and melted, the novel stirring arrangement in accordance with the present invention can then be employed wherein a single coil stack that is positioned about the perimeter of the cavity of the container and the single coil stack extends generally no more than 90% of the longitudinal length L of the cavity of the container and the single coil stack is powered by a single power source.

Referring again to FIG. 7, only the first stack 220A of induction coils that is located about the top portion of the cavity of the container is powered by the power source 230. The second stack 220B of induction coils that is located about the bottom portion of the cavity of the container is not powered by any power source. As such, all of the stirring force on the electrically conductive material in the cavity of the container is generated by the magnetic field or electromotive force produced by the first stack 220A of induction coils. The flow pattern of the liquid electrically conductive material is illustrated by the flow arrows 250. The length of the force arrows 240 represent the relative amount of electromotive force F that is applied to electrically conductive material in the cavity of the container. At the top and bottom of the powered induction coil that is positioned along the longitudinal axis or length of the cavity, the force arrows are smaller or shorter than the force arrows that are located therebetween. As such, the amount of force applied on the electrically conductive material in the cavity of the container is greatest at the location in the cavity that corresponds to the middle of the powered coil stack and is weakest at the location in the cavity that corresponds to the top and bottom of the powered coil stack. As such, as illustrated in FIG. 7, top of first stack 220A that corresponds to the top of the cavity and the bottom of the first stack 220A that corresponds to the mid-region of the cavity have the smaller or shorter force arrows as compared to the other force arrows. The amount of force applied on electrically conductive material in the cavity of the container is illustrated as being the greatest at the top three quarter point of the cavity. The electromotive force F created by only powering first stack 220A creates four quadrants of stirring as illustrated in FIG. 7. Two quadrants of stirring are located in the top quarter of the cavity of the container and two other quadrants of stirring are located in the lower three quarters of the cavity of the container. The two quadrants of stirring located in the top quarter of the cavity are generally equal in size and the stirring speed in such two quadrants is generally the same. Also, the two quadrants of stirring located in the lower three quarters of the cavity are also generally equal in size and the stirring speed in such two quadrants is generally the same. As illustrated in FIG. 7, the size of the two quadrants of stirring in the top region of the cavity are smaller than the size of the two quadrants of stirring that are located below the two quadrants in the top region of the cavity. Also, the speed of rotation of the electrically conductive material in the two quadrants in the top is greater than the speed of rotation of the electrically conductive material in the two quadrants that are located below the two quadrants in the top region of the cavity. Generally, the volume ratio of the smaller quadrant of stirring to the larger quadrant of stirring is 1:1.1-50 (and all values and ranges therebetween). As illustrated in FIG. 7, the volume ratio of the smaller quadrant of stirring to the larger quadrant of stirring is about 1:2.5-5. Generally, the speed of rotation of the smaller quadrant of stirring to the larger quadrant of stirring is 1.1-100:1 (and all values and ranges therebetween). As illustrated in FIG. 7, the speed of rotation of the smaller quadrant of stirring to the larger quadrant of stirring is about 2-15:1.

As illustrated in FIG. 7, the of the electrically conductive material at the top left quadrant of the cavity of the container is illustrated as being counter-clockwise and the stirring direction of the electrically conductive material at the top right quadrant of the container is clockwise; however, it can be appreciated the stirring direction can be reversed for the two top quadrants. The stirring direction of the electrically conductive material at the bottom left quadrant of the cavity of the container is clockwise and the stirring direction of the electrically conductive material at the bottom right quadrant of the container is counter-clockwise; however, it can be appreciated the stirring direction can be reversed for the two bottom quadrants.

Another feature of the present invention is that novel stirring arrangement in accordance with the present invention will have an operating frequency that will be less as compared to the prior art stirring arrangements illustrated in FIGS. 1-6. The lower operating frequency will result in increased stirring forces in the electrically conductive material in the cavity of the container. This lower frequency is a result of parallel coils being disconnected from the power supply output, which results in an increase in the connected total inductance. As such, with a fixed connected capacitance, as the inductance increases, the resonant frequency decreases. In the case of the two stacked induction coils 220A, 220B (illustrated in FIG. 7), when the lower stack 220B is disconnected from the power source/fixed capacitor bank output (no capacitor switching required), the frequency in the novel stirring arrangement drops to approximately

$$\frac{1}{\sqrt{2}} x$$

the operating frequency or 70.7% of operation frequency of when both stacked induction coils 220A, 220B are connected in parallel to the power supply.

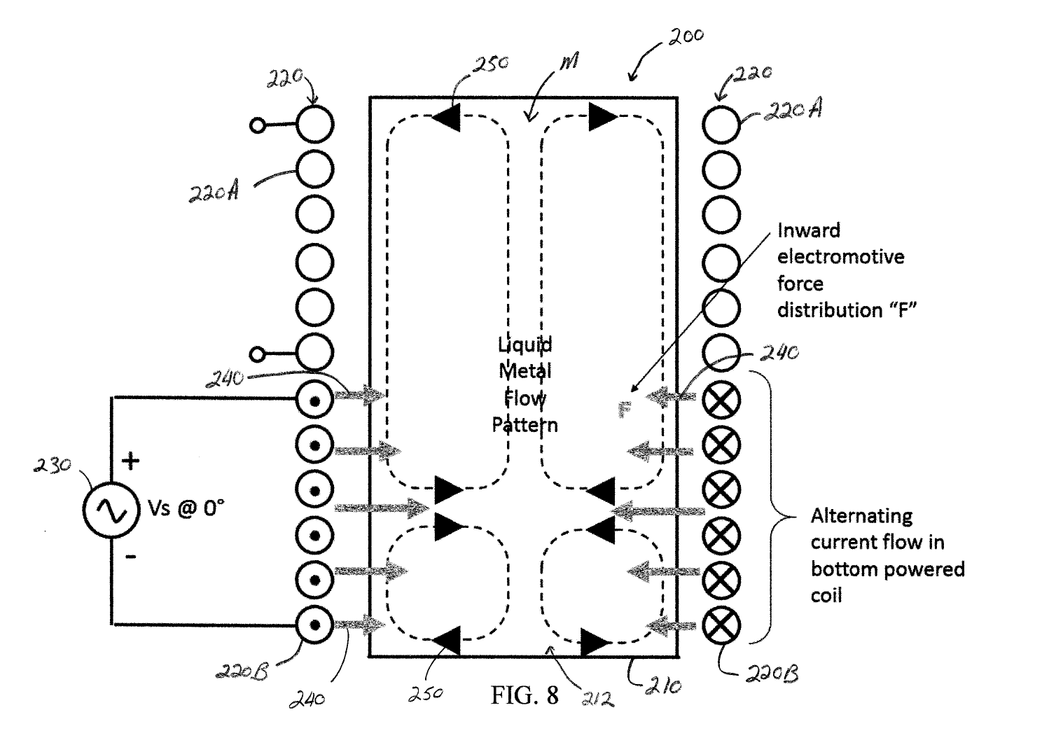

Referring now to FIG. 8, there is illustrated another single-phase induction furnace arrangement 200 in accordance with the present invention. The single-phase induction furnace arrangement includes a similar configuration as described with regard to the single-phase induction furnace illustrated in FIG. 7. However, as illustrated in FIG. 8, the second stack 220B of induction coils is powered by power source 230 and the first stack 220A is not powered during the novel stirring arrangement in accordance with the present invention. As such, all of the stirring force on the electrically conductive material in the cavity of the container is generated by the magnetic field or electromotive force produced by the second stack 220B. The flow pattern of the liquid electrically conductive material is illustrated by the flow arrows 250. As illustrated in FIG. 8, the bottom of the second stack 220B that corresponds to the bottom of the cavity and the top of the second stack 220B that corresponds to the mid-region of the cavity have the smaller or shorter force arrows as compared to the other force arrows. The amount of force applied on the electrically conductive material in the cavity of the container is illustrated as being the greatest at the bottom quarter point of the cavity. The electromotive force F created by only powering second stack 220B creates four quadrants of stirring as illustrated in FIG. 8. Two quadrants of stirring are located in the top quarter of the cavity of the container and two other quadrants of stirring are located in the lower three-quarters of the cavity of the container. The two quadrants of stirring located in the three-quarters of the cavity are generally equal in size and the stirring speed in such two quadrants is generally the same. Also, the two quadrants of stirring located in the lower quarter of the cavity are also generally equal in size and the stirring speed in such two quadrants is generally the same. As illustrated in FIG. 8, the size of the two quadrants of stirring in the top region of the cavity are larger than the size of the two quadrants of stirring that are located below the two quadrants in the top region of the cavity. Also, the speed of rotation of the electrically conductive material in the two quadrants in the top is less than the speed of rotation of the electrically conductive material in the two quadrants that are located below the two quadrants in the top region of the cavity. As illustrated in FIG. 8, the volume ratio of the smaller quadrant of stirring to the larger quadrant of stirring is about 1:2.5-5 and the speed of rotation of the smaller quadrant of stirring to the larger quadrant of stirring is about 2-15:1. The stirring direction of the electrically conductive material at the top left quadrant of the cavity of the container is illustrated as being counter-clockwise and the stirring direction of the electrically conductive material at the top right quadrant of the container is clockwise; however, it can be appreciated the stirring direction can be reversed for the two top quadrants. The stirring direction of the electrically conductive material at the bottom left quadrant of the cavity of the container is clockwise and the stirring direction of the electrically conductive material at the bottom right quadrant of the container is counter-clockwise; however, it can be appreciated the stirring direction can be reversed for the two bottom quadrants.

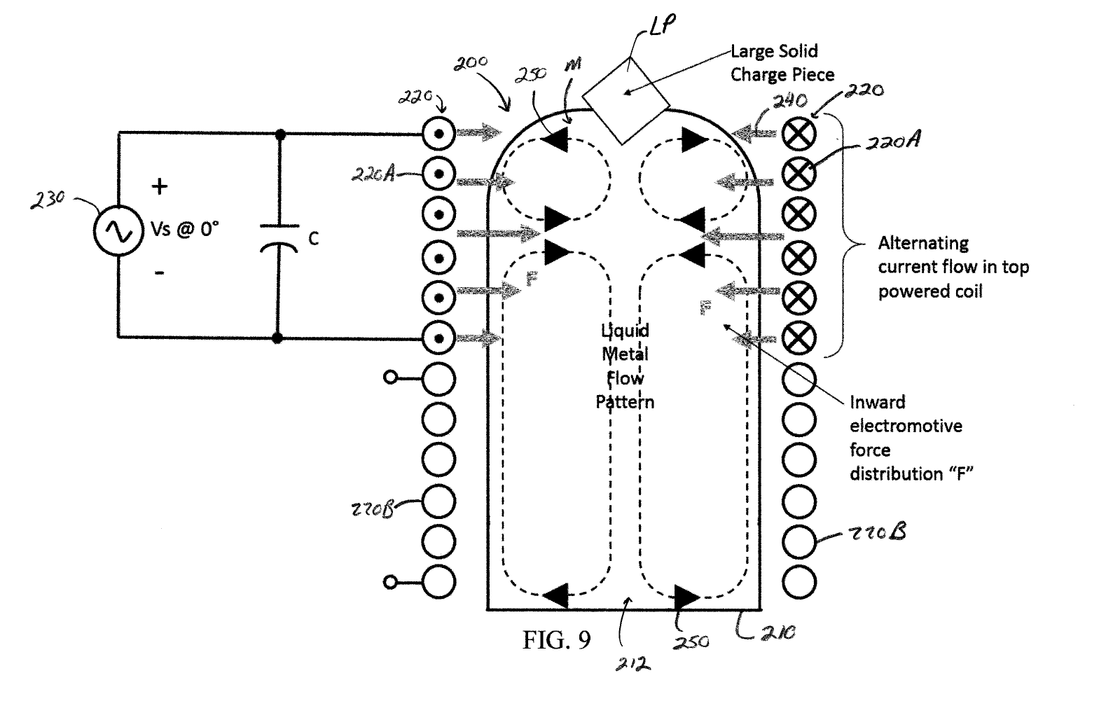

Referring now to FIG. 9, there is illustrated another single-phase induction furnace arrangement 200 in accordance with the present invention. The single-phase induction furnace arrangement includes a similar configuration as described with regard to the single-phase induction furnace illustrated in FIG. 7. However, as illustrated in FIG. 9, the circuit to the induction coil 220 has been modified by the insertion of a capacitor C in parallel to the induction coil. Also, large charged particles LP are illustrated as being optionally added into the top of the cavity of the container to be mixed with the electrically conductive material located in the cavity. Non-limiting examples of charged particles include returns, sprues, gates, risers, plates, bars. The average particle size of the large charged particles generally ranges from at least 3 inches in length to several feet in length. The amount of large charged particles that is typically added to the electrically conductive material, when added, generally constitutes at least 5 wt. % of the total mixture of materials in the cavity of the container, and typically at least 30 wt. % of the total mixture of materials in the cavity of the container. The large charged particles LP can be added to the electrically conductive material prior to the starting the novel stirring process of the present invention and/or during the novel stirring process of the present invention.

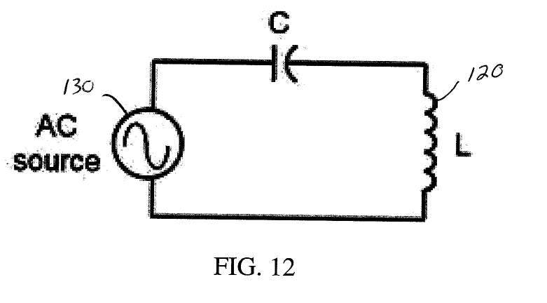

The addition of the capacitor C in the induction circuit as illustrated in FIG. 9 creates a parallel LC resonant circuit. As can be appreciated, a series LC resonant circuit can alternatively be used as illustrated in FIG. 12. As such, a parallel LC resonant circuit or a series LC resonant circuit can be used in the non-limiting embodiments illustrated in FIGS. 7-11. The resonant frequency of the parallel LC resonant circuit occurs when the inductive impedance (X_{L}=2πfL) is equal to the capacitive impedance

$$( XC = \frac{1}{2 π fC} ) .$$

This occurs when

$${f}_{res} = \frac{1}{2 π \sqrt{LC}}$$

where L is the total connected inductance (in henrys) and C is the total connected capacitance (in farads). When such circuits are used to power the induction coil, the power loss during the powering of the induction coils can be reduced by operating the circuit at its resonance frequency due to the resistance in the circuit is significantly reduced.

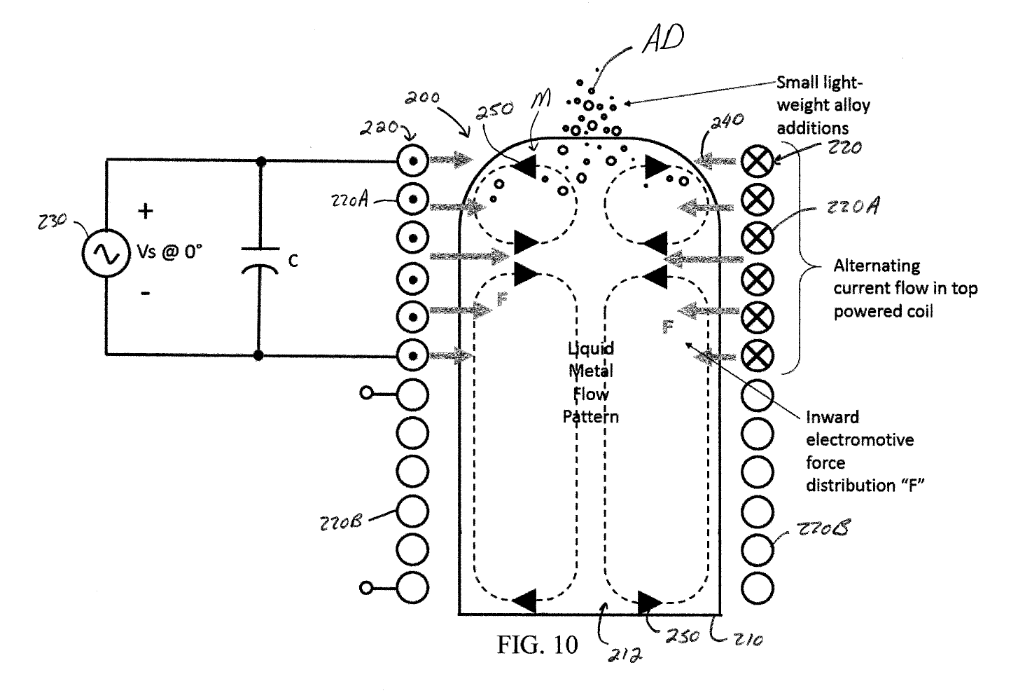

Referring now to FIG. 10, there is illustrated another single-phase induction furnace arrangement 200 in accordance with the present invention. The single-phase induction furnace arrangement includes a similar configuration as described with regard to the single-phase induction furnace illustrated in FIG. 9. However, as illustrated in FIG. 10, small alloy additions AD are illustrated as being optionally added into the top of the cavity of the container to be mixed with the electrically conductive material located in the cavity. Non-limiting examples of the alloy additions include powder, chips, turnings, borings. The average particle size of the alloy additions are generally less than 0.25 inches in length. The amount of alloy additions that is typically added to the electrically conductive material, when used, generally constitutes less than 30 wt. % of the total mixture of materials in the cavity of the container, and typically less than 20 wt. % of the total mixture of materials in the cavity of the container, and more typically less than 10 wt. % of the total mixture of materials in the cavity of the container. The alloy additions can be added to the electrically conductive material prior to the starting the novel stirring process of the present invention and/or during the novel stirring process of the present invention.

Referring now to FIG. 11, there is illustrated another single-phase induction furnace arrangement 200 in accordance with the present invention. The single-phase induction furnace arrangement includes a similar configuration as described with regard to the single-phase induction furnace illustrated in FIG. 7. However, as illustrated in FIG. 11, there are three stacks of induction coils, a first stack 220A, a second stack 220B, and a third stack 220C. The first stack is positioned about the perimeter of the top portion of the container. The second stack is located below the first stack and is positioned about the perimeter of the middle portion of the container. The third stack is located below the second stack and is positioned about the perimeter of the bottom portion of the container. The first stack 220A of induction coils is powered by power source 230 and the second and third stacks are not powered during the novel stirring arrangement in accordance with the present invention. As such, all of the stirring force on the electrically conductive material in the cavity of the container is generated by the magnetic field or electromotive force produced by the first stack 220A. The flow pattern of the liquid electrically conductive material is illustrated by the flow arrows 250. As illustrated in FIG. 11, two quadrants of stirring are located in the top sixth of the cavity of the container and two other quadrants of stirring are located in the lower five-sixths of the cavity of the container. The two quadrants of stirring located in the top sixth of the cavity are generally equal in size and the stirring speed in such two quadrants is generally the same. Also, the two quadrants of stirring located in the lower five-sixths of the cavity are also generally equal in size and the stirring speed in such two quadrants is generally the same. As illustrated in FIG. 11, the size of the two quadrants of stirring in the top region of the cavity are smaller than the size of the two quadrants of stirring that are located below the two quadrants in the top region of the cavity. Also, the speed of rotation of the electrically conductive material in the two quadrants in the top is greater than the speed of rotation of the electrically conductive material in the two quadrants that are located below the two quadrants in the top region of the cavity.

As illustrated in FIG. 11, the volume ratio of the smaller quadrant of stirring to the larger quadrant of stirring is about 1:5-15 and the speed of rotation of the smaller quadrant of stirring to the larger quadrant of stirring is about 2-30:1. The stirring direction of the electrically conductive material at the top left quadrant of the cavity of the container is illustrated as being counter-clockwise and the stirring direction of the electrically conductive material at the top right quadrant of the container is clockwise; however, it can be appreciated the stirring direction can be reversed for the two top quadrants. The stirring direction of the electrically conductive material at the bottom left quadrant of the cavity of the container is clockwise and the stirring direction of the electrically conductive material at the bottom right quadrant of the container is counter-clockwise; however, it can be appreciated the direction of stirring can be reversed for the two bottom quadrants.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. An apparatus for stirring a molten or semi-molten material that is subjected to a magnetic field formed by an energized induction coil, said apparatus including a container having a cavity designed to contain said material, said induction coil including a first induction coil section that is at least partially positioned about said cavity of said container, said first induction coil section is configured to create a magnetic field when energized that affects said material in said cavity and causes said material in said cavity to be stirred, and a power supply that energizes said first induction coil section, said first induction coil section positioned at least partially about an outer perimeter of said container, said first induction coil section positioned along a longitudinal length of said cavity such that when said first induction coil section is energized so as to be the only portion of said induction coil to cause said material in said cavity to be stirred, at least 10% of a longitudinal height of said material in said cavity that is measured along said longitudinal length of said cavity is positioned above or below said energized first induction coil section.

2. The apparatus as defined in claim 1, wherein said power source that energizes said first induction coil section when only said first induction coil section is used to stir said material in said cavity is a single AC power source.

3. The apparatus as defined in claim 1, wherein at least 40% of said longitudinal height of said material in said cavity that is measured along said longitudinal length of said cavity is positioned above or below said energized first induction coil section.

4. The apparatus as defined in claim 1, wherein at least 50% of said longitudinal height of said material in said cavity that is measured along said longitudinal length of said cavity is positioned above or below said energized first induction coil section.

5. The apparatus as defined in claim 1, wherein at least 60% of said longitudinal height of said material in said cavity that is measured along said longitudinal length of said cavity is positioned above or below said energized first induction coil section.

6. The apparatus as defined in claim 1, wherein said induction coil includes a second induction coil section that is energized by the same or different power source used to power said first induction coil section, said first and second induction coil sections configured to heat said material in said cavity, said second induction coil section configured to be deenergized when only said first induction coil section is used to stir said material in said cavity.

7. The apparatus as defined in claim 6, wherein said induction coil includes a third induction coil section that is energized by the same or different power source used to power said first induction coil section, said first, second and third induction coil sections configured to heat said material in said cavity, said second and third induction coil sections configured to be deenergized when only said first induction coil section is used to stir said material in said cavity.

8. A method of stirring a molten or semi-molten material that is subjected to a magnetic field, said method including:
inserting said material in a cavity of a container, said cavity having a longitudinal length that extends from a top to a bottom of said cavity;
providing an induction coil that includes a first induction coil section, said first induction coil section is at least partially positioned about said cavity of said container;
applying power to said induction coil such that said material in said cavity is subjected to a magnetic field that is only formed by said first induction coil, said magnetic field causing said material to be stirred in said cavity, at least 10% of a longitudinal height of said material in said cavity that is measured along said longitudinal length of said cavity is positioned above or below said energized first induction coil section during said stirring of said material in said cavity.

9. The method as defined in claim 8, wherein at least 40% of said longitudinal height of said material in said cavity that is measured along said longitudinal length of said cavity is positioned above or below said energized first induction coil section during said stirring of said material in said cavity.

10. The method as defined in claim 8, wherein at least 50% of said longitudinal height of said material in said cavity that is measured along said longitudinal length of said cavity is positioned above or below said energized first induction coil section during said stirring of said material in said cavity.

11. The method as defined in claim 8, wherein at least 60% of said longitudinal height of said material in said cavity that is measured along said longitudinal length of said cavity is positioned above or below said energized first induction coil section during said stirring of said material in said cavity.

12. The method as defined in claim 8, wherein said induction coil includes a second induction coil section that is energized by the same or different power source used to power said first induction coil section, and including the step of not providing power to said second induction coil section when said first induction coil section is powered to cause said stirring of said material in said cavity.

13. The method as defined in claim 8, including the step of providing power to both said first and second induction coil sections to heat said material in said cavity and thereafter terminating power to said second induction coil section so that only said first induction coil section is used to stir said material in said cavity.

14. The method as defined in claim 12, wherein said induction coil includes a third induction coil section that is energized by the same or different power source used to power said first induction coil section, and including the step of not providing power to second and third induction coil sections when said first induction coil section is powered to cause said stirring of said material in said cavity.

15. The method as defined in claim 14, including the step of providing power to said first, second and third induction coil sections to heat said material in said cavity and thereafter terminating power to said second and third induction coil sections so that only said first induction coil section is used to stir said material in said cavity.

16. The method as defined in claim 8, wherein said energizing of only said first induction coil section during said stirring of said material in said cavity causes first and second top quadrants of said material and first and second bottom quadrants of said material to form and be stirred in said cavity, said first top quadrant of said materials having a rotational direction that is opposite a rotational direction of said second top quadrant, said first bottom quadrant of said material having a rotational direction that is opposite a rotational direction of said second bottom quadrant, a combined volume of said material in said first and second top quadrants at least 10% different from a combined volume of said material in said first and second bottom quadrants.

17. The method as defined in claim 16, wherein said combined volume of said material in said first and second top quadrants at least 30% different from said combined volume of said material in said first and second bottom quadrants.

18. The method as defined in claim 16, wherein said combined volume of said material in said first and second top quadrants at least 50% different from said combined volume of said material in said first and second bottom quadrants.

19. The method as defined in claim 16, wherein a rotational speed of said material in said first and second top quadrants at least 10% different from a rotational speed of said material in said first and second bottom quadrants.

20. The method as defined in claim 19, wherein said rotational speed of said material in said first and second top quadrants at least 30% different from said rotational speed of said material in said first and second bottom quadrants.

21. The method as defined in claim 19, wherein said rotational speed of said material in said first and second top quadrants at least 50% different from said rotational speed of said material in said first and second bottom quadrants.

22. The method as defined in claim 8, wherein said first induction coil section is powered by a single-phase AC power source when said first induction coil section is used to stir said material in said cavity.

23. The method as defined in claim 8, including the step of adding charged particles, alloy particles, or combinations thereof to said material prior to said stirring, during said stirring, or combinations thereof.

24. The method as defined in claim 8, wherein first induction coil section is powered at a resonance frequency of a circuit used to power said first induction coil section.
